(19) United States
(12) Patent Application Publication
(10) Pub. No.: US 2024/0125652 A1
(43) Pub. Date: Apr. 18, 2024

(54) MODULAR INFRARED SENSOR MODULE FOR COOKING

(71) Applicant: Meridian Innovation Pte Ltd, SG (SG)

(72) Inventors: Stanislav Nikolaev MARKOV, Pak Shek Kok (HK); Wai Ming LO, Pak Shek Kok (HK); Nilbert CORONEL, SG (SG)

(21) Appl. No.: 18/379,647

(22) Filed: Oct. 12, 2023

Related U.S. Application Data
(60) Provisional application No. 63/379,447, filed on Oct. 14, 2022.

(51) Int. Cl. G01J 5/12; G01J 5/061

(52) U.S. Cl. CPC G01J 5/12; G01J 5/061; G01J 2005/0077

(57) ABSTRACT

Disclosed is a sensor module. The sensor module may be an infrared sensor module for sensing temperature of food being cooked. The sensor module may be implemented or integrated into a closed cooking environment, such as an oven, or in an open cooking environment such as a range. The sensor module includes an air chamber unit to generate an air curtain over the front and back surfaces of a glass cover protecting the sensor. The air curtain prevents condensation on the cover and to maintain it cool. The air curtain improves accuracy of temperature sensed during cooking.

### CROSS-REFERENCE TO RELATED APPLICATION

This application claims the benefit of U.S. Provisional Application Ser. No. 63/379,447, filed on Oct. 14, 2023, which is herein incorporated by reference in its entirety for all purposes.

### FIELD OF THE INVENTION

The present disclosure generally relates to implementing infrared or thermal sensors for cooking applications. More particularly, the disclosure relates to an infrared detector module utilizing an air curtain for cooling as well as preventing condensation for accurate temperature sensing in a cooking environment.

### BACKGROUND

Infrared sensors have been employed for cooking purposes. For example, microwave ovens have been implemented with infrared sensors to provide temperature readings of the food being cooked. This facilitates determining whether the food is cooked to a desired temperature. Typically, a sensor senses the temperature through a sensor window. The sensor window, for example, may be a silicon or germanium window which is transparent to infrared radiation (IR). During cooking, the window may experience high temperatures as well as condensation. However, elevated temperatures may render the silicon or germanium window non-IR transmissive while condensation obscures the IR window. These effects may affect the accuracy of temperature readings by the infrared sensor.

The present disclosure is directed to a cost-effective and compact infrared sensor module which can provide accurate temperature readings in a cooking environment.

### SUMMARY

Embodiments of the present disclosure generally relate to devices or modules and methods of forming thereof. In one embodiment, an imaging sensor module is disclosed. The imaging sensor module includes a face plate having front and back major face plate surfaces. The face plate includes a face plate opening which serves as a window for an imaging sensor of the sensor module. The imaging sensor module also includes an air chamber unit. The air chamber unit includes an air chamber plate with front and back major air chamber plate surfaces. The front air chamber plate surface is disposed on the back face plate surface. The air chamber plate includes an air chamber plate opening which corresponds to the face plate opening. The air chamber unit also includes an imaging cover having front and back major cover surfaces. The front imaging surface is disposed on the back air chamber plate surface and covers the air chamber plate opening. The air chamber unit further includes an air conduit disposed on the back air chamber plate surface. The air conduit is configured to produce an air curtain which serves as a barrier to prevent condensation on the cover and to maintain the cover cool. The imaging sensor module also includes a sensor unit. The sensor unit includes a sensor bracket mounted to the sensor module. The sensor unit also includes the imaging sensor mounted onto the sensor bracket. The sensor is configured to view through the imaging cover, the air chamber plate opening and the face plate opening. The sensor unit further includes a sensor controller for controlling operation of the imaging sensor.

In another embodiment, a method for forming an imaging sensor module is disclosed. The method includes providing a face plate having front and back major face plate surfaces. The face plate includes a face plate opening which serves as a window for an imaging sensor of the sensor module. The method also includes providing an air chamber unit. The air chamber unit includes an air chamber plate with front and back major air chamber plate surfaces. The air chamber plate includes an air chamber plate opening. The air chamber unit also includes an imaging cover having front and back major cover surfaces. The front imaging surface is disposed on the back air chamber plate surface and covers the air chamber plate opening. The air chamber unit further includes an air conduit disposed on the back air chamber plate surface. The air conduit is configured to direct airflow from an air supply unit across the front and back cover surfaces to produce an air curtain which serves as a barrier to prevent condensation on the cover and to maintain the cover cool. The method also includes attaching the air chamber unit to the back face plate surface. The air chamber plate opening corresponds to the face plate opening. The method further includes providing a sensor unit. The sensor unit includes a sensor bracket with the imaging sensor mounted thereon and a sensor controller for controlling operation of the imaging sensor. The method also includes attaching the sensor bracket of the sensor unit to the sensor module. The imaging sensor is configured to view through the imaging cover, the air chamber plate opening and the face plate opening.

These and other advantages and features of the embodiments herein disclosed will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are incorporated in and form part of the specification in which like numerals designate like parts, illustrate preferred embodiments of the present disclosure and, together with the description, serve to explain the principles of various embodiments of the present disclosure.

FIGS. 1a-1d show various simplified views of an embodiment of an infrared sensor module;

FIGS. 2a-2b show various simplified exploded views of an embodiment of an infrared sensor module;

FIGS. 3a-3b show various simplified views of an embodiment of an air chamber unit;

FIGS. 4a-4b show various simplified cross-sectional views of an embodiment of an air chamber unit illustrating the airflow of the air curtain;

FIGS. 5a-5b show various simplified views of another embodiment of an air chamber unit;

FIG. 6 shows a simplified cross-sectional view of another embodiment of the air chamber unit illustrating the airflow of the air curtain;

FIGS. 7a-7b shows simplified views of different applications of the infrared sensor module for use in a cooking environment.

### DETAILED DESCRIPTION

Embodiments generally relate to infrared sensor modules employed in cooking applications. An infrared sensor module may incorporate a thermoelectric-based micro-electrical mechanical system (MEMS) detector embedded into an integrated circuit (IC) with high complementary metal oxide semiconductor (CMOS) integration. Such MEMS sensors are described in, for example, U.S. patent application Ser. No. 15/647,284, U.S. patent application Ser. No. 15/653,558, U.S. patent application Ser. No. 16/809,561, U.S. patent application Ser. No. 17/439,797 and International application No. PCT/SG2022/050830, which are incorporated by reference for all purposes. Other types of infrared sensors may also be employed for the infrared sensor module.

The sensor module can be implemented in a closed environment, such as an oven. The oven can be any type of oven. For example, the oven can be a gas or electric oven, microwave oven, convection oven, combination steam/convection oven as well as other types of ovens. In a closed environment, the sensor module may be an integrated sensor module. In other embodiments, the oven may be implemented in an open environment, such as a range. For example, the sensor module may be disposed on a range hood located over the range. In an open cooking environment, the sensor module may be a standalone sensor module or part of the hood unit.

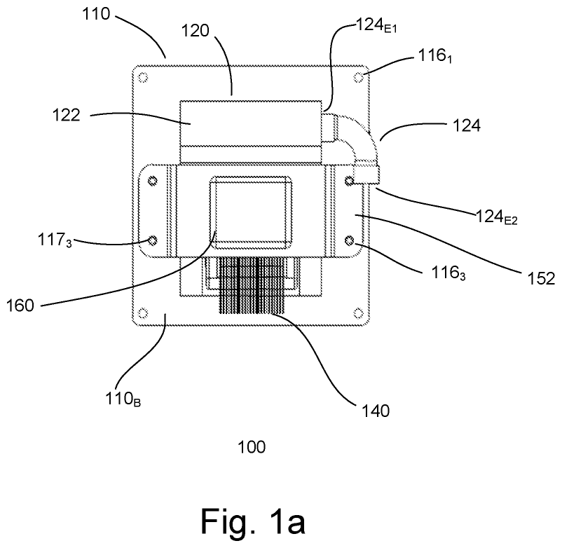

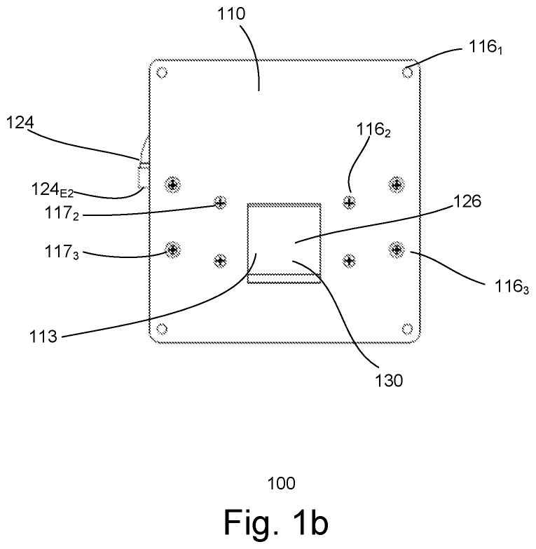

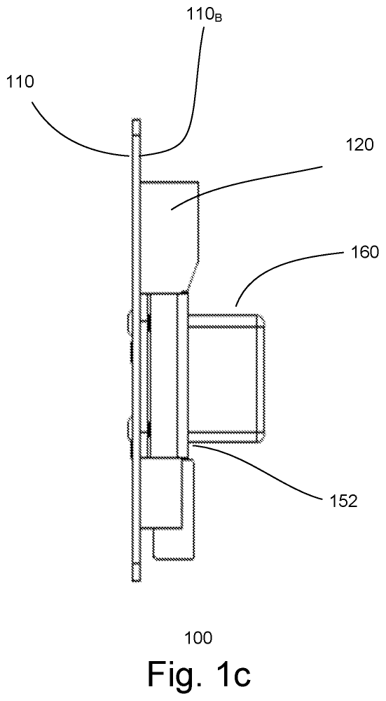

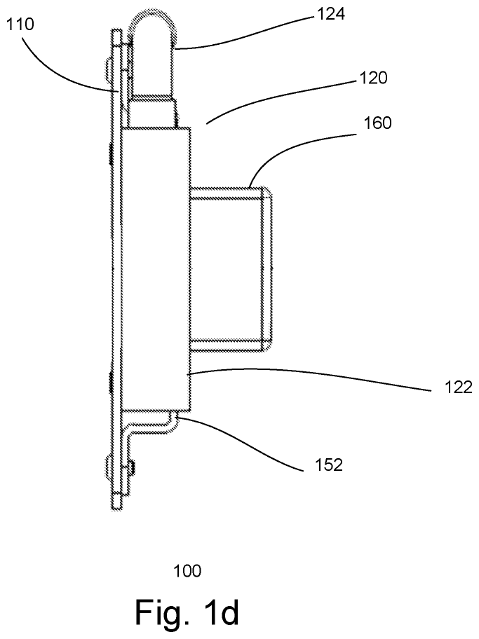

FIGS. 1a-1d show various simplified views of an embodiment of an infrared sensor module. In particular, FIG. 1a shows a back view, FIG. 1b, shows a front view (facing the food), FIG. 1c shows a side view and FIG. 1d shows another side view. Referring to FIGS. 1a-1d, the sensor module includes a face plate 110. The face plate serves as a support plate for the sensor module. For example, the various components of the sensor module are mounted onto the face plate. The face plate is made of a rigid material to support the components of the sensor module. For example, the face plate is formed from a metallic material, such as steel, aluminum or an alloy. Other types of non-metallic rigid materials, such as ceramic, may also be useful.

In one embodiment, the face plate includes a face plate opening 113. The face plate opening, for example, is an opening in the face plate which enables the sensor module to thermally image the food being cooked. In the case that the face plate is formed from an IR transmissive material, the face plate opening may not be necessary.

The face plate includes fastening holes. In one embodiment, the fastening holes include first, second and third fastening holes 116₁, 116₂ and 116₃. The first fastening holes are employed for mounting the sensor module for operation. For example, the first fastening holes are used to mount the sensor module to the oven or range hood. The second fastening holes are employed for mounting an air chamber unit 120 to the face plate using second fasteners 117₂ and the third fastening holes are employed for mounting a sensor unit 150 to the face plate using third fasteners 117₃.

The air chamber unit 120 is attached to the face plate back surface 110_{B}. As shown, the air chamber unit includes an air chamber 122. The air chamber includes an air chamber opening 126. The air chamber opening, for example, corresponds to the face plate opening to enable imaging of the food by the sensor.

In one embodiment, an IR transmissive cover 130 seals the air chamber opening. The cover, in one embodiment, is attached to the air chamber from a back surface thereof. In one embodiment, the IR transmissive cover may be a filtered cover. The filtered cover is configured to transmit IR radiation while blocking other radiation. In one embodiment, the cover may be a silicon or germanium cover. In one embodiment, the cover may be a 1 mm thick germanium cover. Other types or thicknesses of the cover may also be useful. The cover, in one embodiment, includes front and back opposing cover surfaces. The front cover surface faces the food being cooked. In one embodiment, the front cover surface is disposed on the back face plate surface. An adhesive may be employed to attach the cover to the face plate. Other types of locking mechanisms may also be useful.

In one embodiment, the air chamber unit includes an air inlet 124 connected to the air chamber. The air inlet includes first and second air inlet ends 124_{E1} and 124_{E2}. The first air inlet end is connected to the air chamber. In one embodiment, the second air inlet end is connected to an external air supply unit. The air supply unit may include a motor and pump for generating airflow into the air chamber via the air inlet. Other types of air supply units may also be useful.

In other embodiments, the air supply unit may be an integrated air supply unit. For example, the air supply unit may be part of the air chamber unit. The integrated air supply unit may be a fan unit. Other types of air supply units may also be useful. In such cases, an air inlet may not be necessary.

The air chamber unit is configured to direct the airflow from the air supply unit to both front and back cover surfaces. In one embodiment, the air chamber unit is configured to introduce a constant stream of laminar flow of air over the front and back cover surfaces. For example, the air chamber includes small front and back cover surface openings which are in flow communication to the front and back surfaces of the cover. The small openings cause an increase in air pressure, forcing air to flow through the openings and over the front and back surfaces of the cover. The airflow is in a single direction over the cover. The constant airflow over the front and back cover surfaces forms an air curtain.

The air curtain serves as a barrier, protecting the sensor module from the heat and moisture of the cooking environment. For example, the air curtain serves to cool the cover and prevents condensation on the cover. Keeping the cover cool improves IR transmission. For example, in the case of silicon and/or germanium, IR transmission is inhibited at elevated temperatures. For example, silicon and germanium become opaque to IR at elevated temperatures. Also, preventing condensation avoids erroneous temperature readings by the sensor of the sensor unit. In a closed environment, such as an oven, one or more air vents may be provided to expel the air injected by the air chamber.

As discussed, the air chamber is configured to generate air flow over the front and back surfaces of the cover through the front and back cover surface openings. For example, front airflow is generated through the front cover surface opening and over the front cover surface; back airflow is generated through the back cover surface opening and over the back cover surface. In one embodiment, the back airflow has a higher flow velocity than the front airflow. This can be achieved from making the back cover surface cover opening larger than the front cover surface opening, enable air to the back cover surface to be released at a faster rate than the front.

The front airflow serves to reduce or prevent build up, such as oil or grease, on the front cover surface while the back airflow serves to reduce or prevent condensation and to keep the IR transmissive cover cool.

The sensor unit includes a sensor attached to a sensor bracket 152. The sensor bracket, in one embodiment, is made of metal, such as steel or aluminum. Other types of metal or rigid material sufficient to support the components of the sensor module may also be used. The sensor bracket is attached to the back surface of the face plate by third fasteners 117₃ through the third fastening holes 116₃. In one embodiment, the sensor is an IR camera or thermal sensor. In one embodiment, the thermal sensor is embedded into a CMOS IC device. For example, the thermal sensor is an integrated CMOS MEMS sensor. Other types of imaging sensors, including non-IR sensors, may also be useful. In a preferred embodiment, the sensor has a large field of view (FOV) sufficient to cover the complete cooking area. In the case of a cooking area with multiple cooking areas, such as an oven with multiple stoves, multiple sensors can be implemented to cover the complete cooking area. Sensor circuitry (electronics) is connected to the sensor for controlling sensor operation. A sensor housing 160 encases the sensor and sensor electronics.

In one embodiment, a heat dissipation unit 140 is provided for the sensor module. The heat dissipation unit is configured to keep the sensor module cool. The heat dissipation unit, in one embodiment, is configured to contact the IR transmissive cover. For example, the heat dissipation unit is configured to absorb excess heat from the cover, keeping it cool. The back airflow from the air chamber further cools the heat dissipation unit. This improves the cooling performance of the heat dissipation unit, maintaining optimal functional performance of the sensor module.

In one embodiment, the heat dissipation unit includes a heat dissipator. The heat dissipator may be a heat sink or heat pipe. Other types of heat dissipators may also be useful. For example, the heat dissipator may be a low-conductivity silicone. The silicone may be disposed on the cover and back air chamber surface as well as other parts of the sensor module to facilitate cooling of the cover. The heat dissipation unit may include multiple heat dissipators, such as heat sink and silicone.

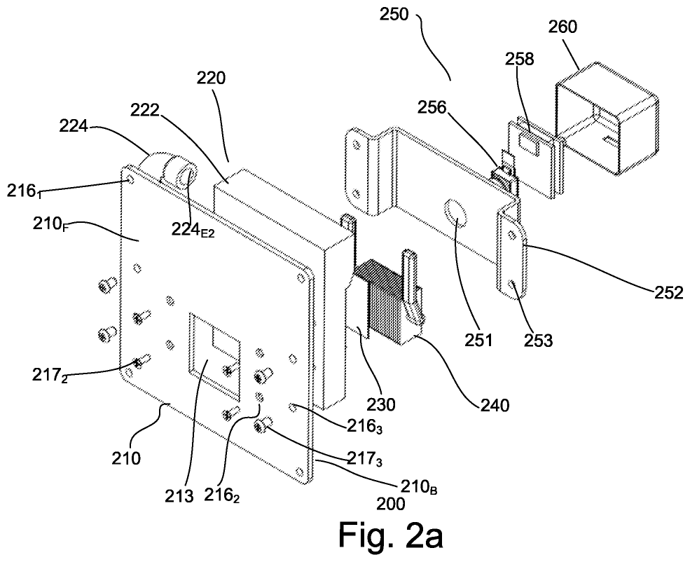

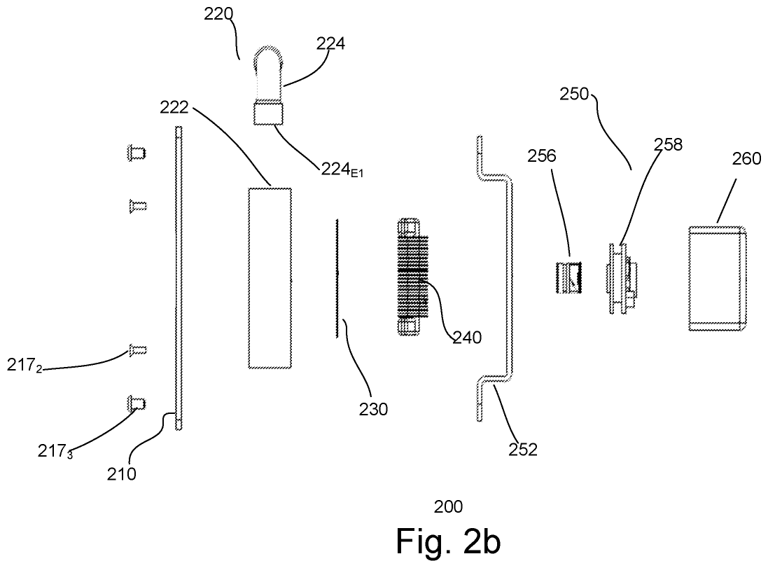

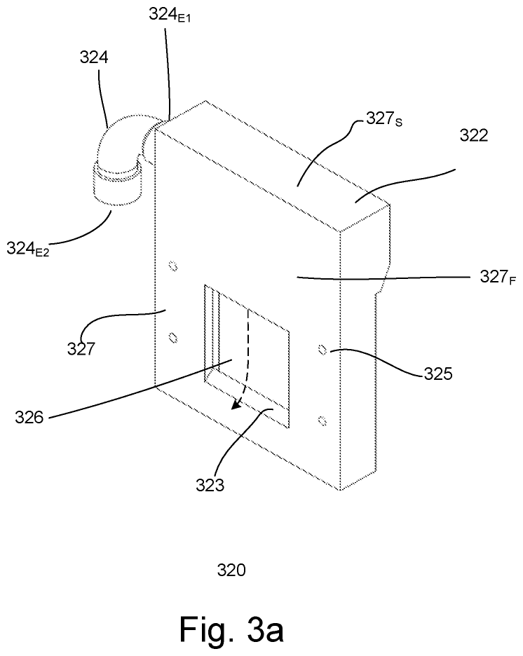

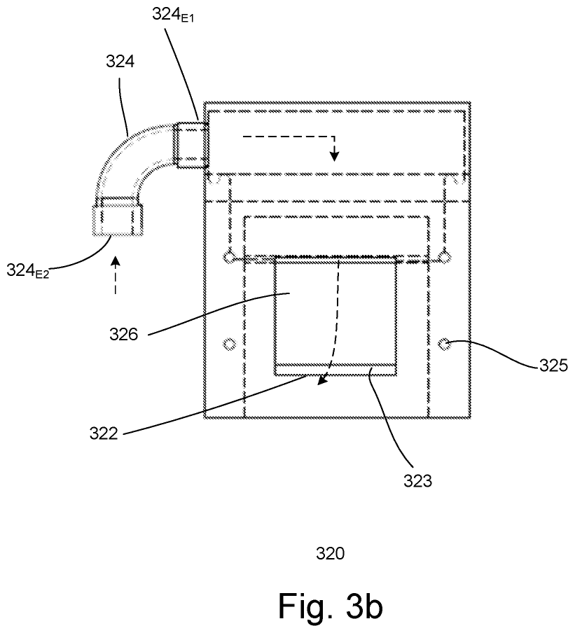

FIGS. 2a-2b show different simplified exploded views of an embodiment of a sensor module or module assembly 200. In particular, FIG. 2a shows an isometric exploded view while FIG. 3b shows a side exploded view. The sensor module is similar to that shown in FIGS. 1a-1d. Common elements may not be described or described in detail.

Referring to FIGS. 2a-b, the module assembly includes a face plate 210 with front and back surfaces 210_{F} and 210_{B}. The face plate is made of a rigid material such as metal, including steel and aluminum. Other types of rigid materials sufficient to support the various components of the assembly and to survive the cooking environment may also be useful. The face plate may be formed by casting, molding or stamping. Other techniques for forming the face plate may also be useful.

The face plate includes a face plate opening 252. The face plate also includes fastening holes. In one embodiment, the fastening holes include first, second and third sets of fastening holes 216₁, 216₂ and 216₃. The first set of fastening holes is employed for mounting the sensor module for operation using the first set of fasteners (not shown). The second set of fastening holes is employed for mounting an air chamber unit 220 to the face plate using a second set of fasteners 217₂ while the third set of fastening holes is employed for mounting a sensor unit 250 to the face plate using a third set of fasteners 217₃.

Attached to the face plate back surface is the air chamber unit 220. The air chamber unit includes an air chamber 222. The air chamber includes an air chamber opening. The air chamber opening, for example, corresponds to the face plate opening. In one embodiment, an IR transmissive cover 230 is disposed over the air chamber opening. The cover, in one embodiment, is attached to the air chamber from a back thereof. In one embodiment, the IR transmissive cover may be a filtered cover. In one embodiment, the cover may be a silicon or germanium cover. Other types of covers may also be useful. The cover, in one embodiment, includes front and back opposing cover surfaces. The front cover surface faces the food being cooked. In one embodiment, the front cover surface is disposed on the back face plate surface. An adhesive may be employed to attach the cover to the face plate.

In one embodiment, the air chamber unit includes an air inlet 224 connected to the air chamber. In one embodiment, a first inlet end 224_{E1} is configured to connect to the air chamber while a second inlet end 224_{E2} is configured to connect to an external air supply unit for supplying airflow to the air chamber via the air inlet. Alternatively, the air supply unit may be an integrated air supply unit which is part of the air chamber unit. The air chamber includes an air chamber opening (not shown) which corresponds to the face plate opening. For example, the air chamber opening exposes the face plate opening with the cover, enabling the sensor to sense the temperature of the food being cooked.

The air chamber may be made of a rigid material such as metal, including steel and aluminum. Other types of rigid materials may also be useful. The air chamber is configured to direct the airflow from the air supply unit to both front and back cover surfaces. For example, front airflow is provided over the front cover surface and back airflow is provided over the back cover surface. In one embodiment, a constant stream of laminar flow of air is provided over the front and back cover surfaces. An air conduit in the air chamber directs a constant airflow over the front and back cover surfaces, producing an air curtain. The air curtain protects the sensor module from the heat and moisture from the cooking environment. For example, the air curtain serves to cool the cover and prevents condensation on the cover. In the case of a closed environment, one or more air vents may be provided to expel the air injected by the air chamber.

In one embodiment, front airflow is generated through the front cover surface opening and over the front cover surface; back airflow is generated through the back cover surface opening and over the back cover surface. In one embodiment, the back airflow has a higher flow velocity than the front airflow. The front airflow serves to reduce or prevent build up, such as oil or grease, on the front cover surface while the back airflow serves to reduce or prevent condensation and keeps the IR transmissive cover cool.

The sensor unit 250 is attached to the back surface of the face plate. In one embodiment, the sensor unit includes a sensor bracket 252 with sensor fastening holes 253. The sensor bracket, in one embodiment, is made of metal, such as steel or aluminum. Other types of metal or rigid material sufficient to support the components of the sensor unit may also be used. The sensor bracket is attached to the back surface of the face plate by the third set of fasteners 217₃ through the third set of fastening holes 216₃ and the sensor fastening holes In one embodiment sensor bracket includes a sensor bracket opening 251. A sensor 256 is mounted on the bracket. The bracket opening enables the sensor to sense the food being cooked through the face plate and air chamber openings. The sensor is connected to sensor electronics 258 on, for example, a circuit board to control the operation of the sensor.

In one embodiment, the sensor is an IR camera or thermal sensor. Other types of sensors may also be useful. Preferably, the sensor has a large FOV sufficient to cover the complete cooking area. A sensor housing 260 encases the sensor and sensor electronics.

In some embodiments, a heat dissipation unit 240 is provided for the sensor module. The heat dissipation unit is configured to keep the sensor cool. The heat dissipation unit, for example, is attached to the IR transmissive cover to absorb excess heat. In one embodiment, the airflow from the air chamber unit flows to the back surface of the IR transmissive cover and through the heat dissipation unit. This helps cool the heat dissipation unit, improving its performance. In one embodiment, the airflow to the back surface of the IR transmissive cover is expected to be higher than the front surface. The heat dissipation unit is configured to avoid obscuring the view of the sensor. For example, the heat dissipation unit does not interfere with or obstruct any of the openings, such as the face plate opening, the air chamber opening and the sensor bracket opening.

In one embodiment, the heat dissipation unit includes a heat dissipator. The heat dissipator may be a heat sink or heat pipe thermally coupled to the IR transmissive cover. Other types of heat dissipators may also be useful. For example, the heat dissipator may be a low-conductivity silicone. The silicone may be disposed between the sensor and the sensor bracket as well as between the sensor bracket and back surface of the face plate. The heat dissipation unit may include multiple heat dissipators, such as heat sink and silicone.

FIGS. 3a-3b show various simplified views of an embodiment of an air chamber unit 320. In particular, FIG. 3a shows an isometric view and FIG. 3b shows a front view. The air chamber unit is similar to the ones described in FIGS. 1a-1d and 2a-2b. Common elements may not be described or described in detail.

As shown, the air chamber unit includes an air chamber 322. The air chamber is a rectangular structure with a planar chamber plate 327. The air chamber may be formed from a rigid material. For example, steel, aluminum or other types of rigid materials may be used. A front or outer surface 327F of the chamber plate is configured to be mounted to the back surface of the face plate. For example, the planar chamber plate includes chamber fastening holes aligned with the second set of fastening holes 325 on the face plate. The air chamber includes chamber side surfaces 327s extending from the edges of the planar chamber plate. The planar plate includes a chamber opening or window 326. The window, for example, is a rectangular window and is aligned with the face plate opening.

In one embodiment, the air chamber includes an air conduit. An air inlet 324 is connected to the air conduit. For example, a first inlet end 324_{E1} is connected to one of the chamber side surfaces and is in fluid communication with the air conduit. A second inlet end 324_{E2} is configured to connect to an external air supply unit. The air supply unit generates air flowing into the air chamber. The air conduit is configured to produce airflow on the front and back surfaces of the cover attached to the back surface of the face plate to form an air curtain. For example, back airflow is generated over the back cover surface and front air front airflow is generated over the front cover surface. As shown, the direction of airflow of the air curtain is from a top edge (starting edge) to a bottom edge (end edge) of the air chamber window, as illustrated by the dotted arrow. Providing other directions of airflow for the air curtain may also be useful.

In one embodiment, the top or starting edge includes front and back air cover surface openings. The openings, for example, are in flow communication with the air conduit and are separated by the cover. Airflow from the air supply unit is configured to flow over the front and back cover surfaces through the small cover surface openings. In one embodiment, back airflow is configured to have a higher flow rate or velocity than the front airflow. The bottom or end edge of the air chamber window 323 includes a beveled edge to avoid hindering or disturbing the airflow of the air curtain. The complete end edge may be beveled or only a portion of the end edge is a beveled edge.

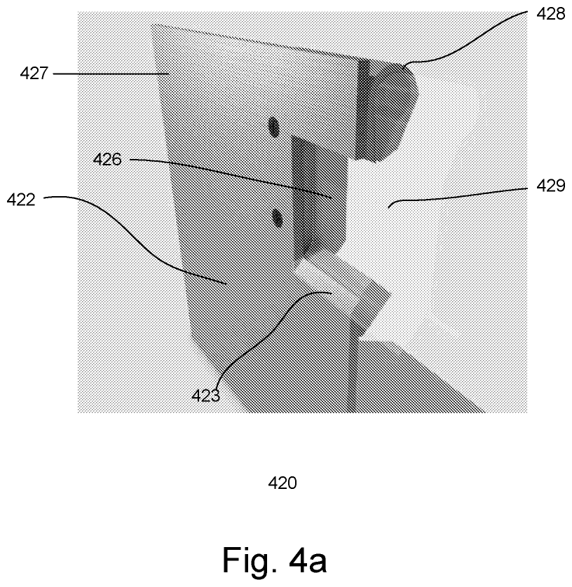

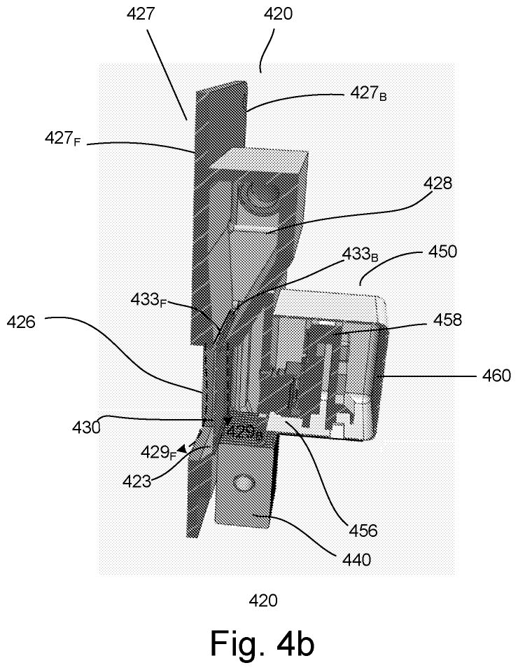

FIGS. 4a-4b show various simplified cross-section views of an embodiment of an air chamber unit 420 illustrating airflow therein. In particular, FIG. 4a shows an isometric cross-sectional view and FIG. 4b shows another isometric cross-sectional view which includes the sensor unit 450. The air chamber unit is similar to the ones described in FIGS. 1a-1d, 2a-2b and 3a-3b. Common elements may not be described or described in detail.

Referring to FIGS. 4a-4b, a planar chamber plate 427 of the air chamber 422 includes a chamber window 426. The front surface 427_{F} of the planar chamber plate is configured to mate with the back surface of the face plate. A cover 430 is attached to a back surface 427_{B} of the planar chamber plate. An air conduit 428 of the air chamber directs airflow 429 from the air supply unit to the front and back surfaces of the cover. The air conduit is, for example, an air container for containing air from the air supply. Front and back airflow are indicated by dotted arrows 429_{F} and 429_{B}. Due to the beveled edge 423 of the chamber window, airflow is not interrupted, providing smooth airflow for the air curtain. As shown, the beveled edge is a partial beveled edge from the back chamber plate surface.

The cover attached to the back chamber plate surface forms a front cover surface opening 433_{F} and a back cover surface opening 433_{B}. For example, the cover is attached to non-starting edges of the back chamber plate surface. The cover surface openings are in airflow communication with the air conduit. The cover surface openings are relatively small. This cause air pressure to increase in the air conduit, generating airflow through the cover surface openings. In one embodiment, front airflow is generated through the front cover surface opening and over the front cover surface; back airflow is generated through the back cover surface opening and over the back cover surface. In one embodiment, the back airflow has a higher flow velocity than the front airflow. This can be achieved by forming the back cover surface opening to be larger than the front cover surface opening. Other techniques for configuring higher velocity air flow for the back cover surface than the front cover surface may also be useful. The front airflow serves to reduce or prevent build up, such as oil or grease, on the front cover surface while the back airflow serves to reduce or prevent condensation and keeps the IR transmissive cover cool.

As discussed, direction of air flow can be configured in other directions (direction other than from top edge to bottom edge of air chamber opening. This can easily be configured by arranging the cover surfaces openings on the designated starting edge of the airflow. The designated end edge will be a beveled or partial beveled edge.

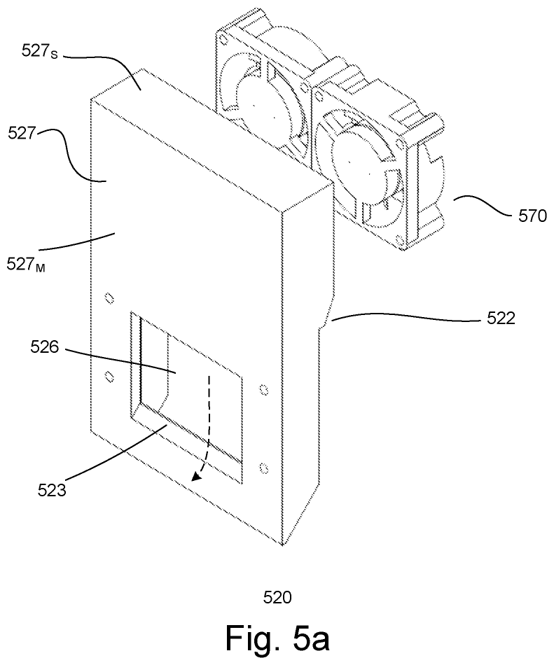

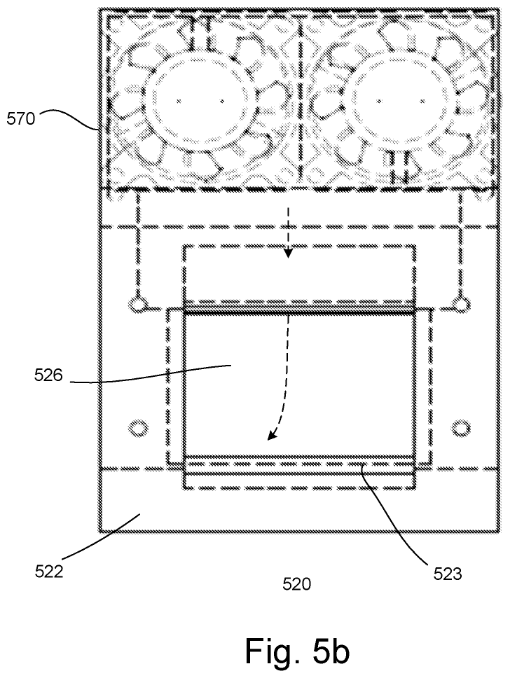

FIGS. 5a-5b show various simplified views of an embodiment of an air chamber unit 320. In particular, FIG. 5a shows an isometric view and FIG. 5b shows a front view. The air chamber unit is similar to the ones described in FIGS. 1a-1d, 2a-2b and 3a-3d. Common elements may not be described or described in detail.

The air chamber unit includes an air chamber 522 with a planar chamber plate 527. An outer surface 527_{M} of the chamber plate is configured to mount to the back surface of the face plate. Chamber side surfaces 527_{S} extend from the edges of the planar chamber plate. The planar plate includes a chamber opening 526. The window, for example, is a rectangular window and is aligned with the face plate opening.

In one embodiment, the air chamber is configured to accommodate an integrated air supply unit 570. For example, the air chamber includes space to accommodate the integrated air supply unit. In one embodiment, the air supply unit may be a fan unit. As shown, the fan unit includes dual fans for supplying airflow to the air chamber. Other types of air supply units may also be useful.

The air chamber includes an air conduit in airflow communication with the integrated air supply unit. The air conduit is configured to produce airflow on the front and back surfaces of the cover attached to the back surface of the face plate to form an air curtain. In one embodiment, the airflow to the back surface of the IR transmissive cover is configured with a higher airflow than the front cover surface. In one embodiment, the direction of airflow of the air curtain is from a top edge to a bottom edge of the air chamber window, as illustrated by the dotted arrow. In one embodiment, the bottom edge of the air chamber window 523 is a beveled edge to avoid hindering or disturbing the airflow of the air curtain. Other configurations of the integrated air supply unit as well as direction of air flow may also be useful.

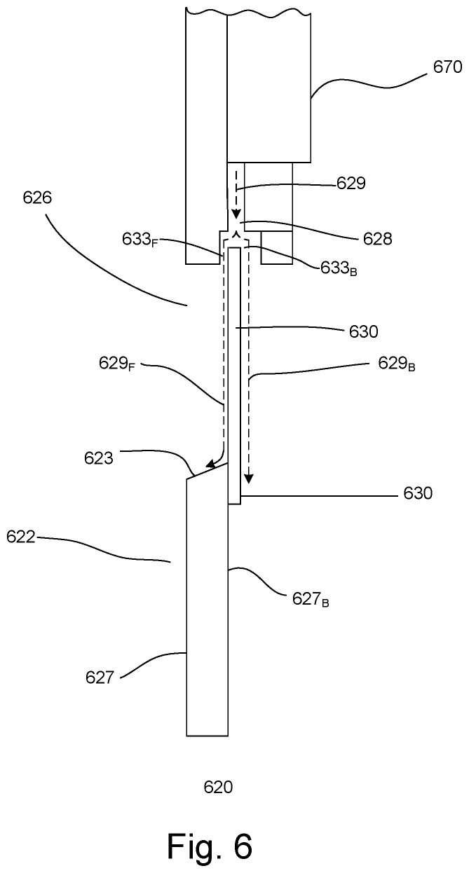

FIG. 6 shows a simplified side cross-sectional view of an air chamber unit illustrating the airflow therein. The air chamber unit is similar to the ones described in FIGS. 1a-1d, 2a-2b, 3a-3b, 4a-4b and 5a-5b. Common elements may not be described or described in detail.

As shown, a planar chamber plate 627 of the air chamber 622 includes a chamber window 626. A cover 630 is attached to a back surface 627_{B} of the planar chamber plate. An air conduit 628 of the air chamber directs airflow 429 from the integrated air supply unit 670 to the front and back surfaces of the cover (air flow 629_{F} and 629_{B}). As discussed, the back airflow has a higher velocity than the front airflow. This can be achieved by configuring the back cover surface opening to be larger than the front cover surface opening. The gap distance between the cover surface and the opposing edge opening should remain consistent throughout the length of the opening for the front and back cover surface openings. Due to the beveled edge 623 of the chamber window, airflow is not interrupted, providing smooth airflow for the air curtain.

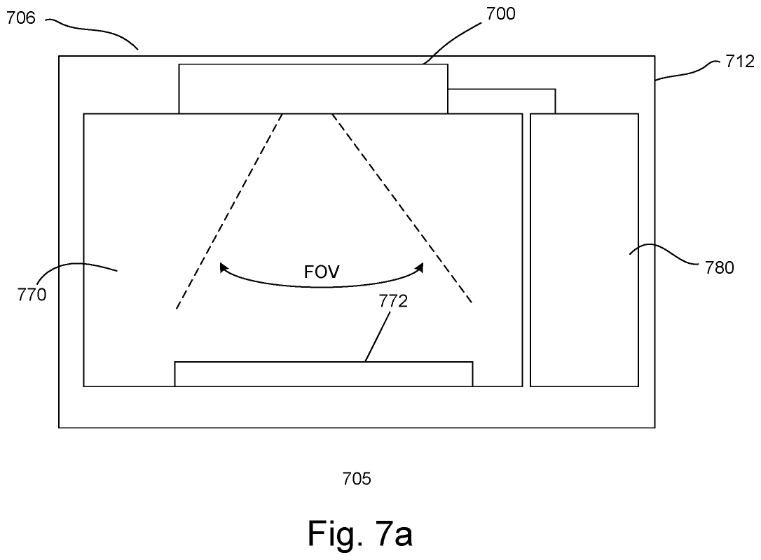

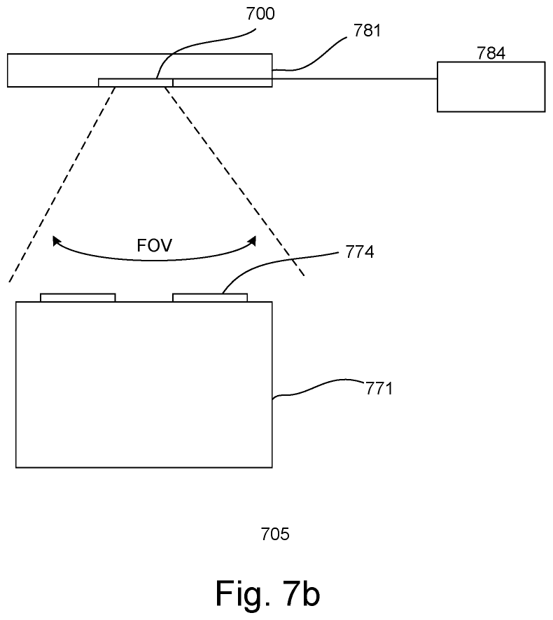

FIGS. 7a-7b show different applications 705 of the sensor module 700 in a cooking environment. Referring to FIG. 7a, the sensor module is integrated into a closed cooking environment. For example, the sensor module is integrated as part of an oven 706. As shown, the oven includes an oven housing 712. Within the housing, cooking and control compartments 770 and 780 are provided. The cooking compartment is the space in which food 772 is cooked while the control environment houses control electronics for operating the oven.

In one embodiment, a thermal sensor module 700 is disposed on a top or roof of the cooking compartment. The thermal or infrared sensor module includes an infrared sensor. The thermal sensor module is configured to sense the temperature of the food being cooked. For example, the thermal sensor senses the surface temperature of the food being cooked. In one embodiment, the sensor includes a field of view (FOV) which is sufficient to sense the complete area in which the food is being cooked. This enables the use of a single sensor. Alternatively, multiple sensors may be employed to sense the complete cooking area.

As shown, the thermal sensor is controlled by the oven controller. The components of the oven controller may be disposed in the controller compartment. In the case where the sensor module includes an external air supply unit, the air supply unit is located in the control compartment. The air supply unit is in fluid communication with the air chamber by, for example, tubing or pipe.

The oven controller controls the operations of the oven, including providing power to the sensor module. In one embodiment, the oven controller includes a processing unit, an input panel and an output panel. The input panel provides a user an input interface to set the desired cooking settings or parameters, such as the target temperature (of the food being cooked) and cooking power or temperature, depending on the type of oven, as well as other cooking parameters. The processing unit controls the oven based on the input cooking parameters by the user. In addition, the processing unit controls the air supply unit to supply airflow to the sensor module to keep it cool and prevent condensation of the sensing window when cooking starts. During cooking, the processing unit continuously senses the food temperature. The output panel may include an output interface to provide the user with the current cooking information, such as food temperature (temperature of food being cooked) as well as oven temperature and time of cooking. Other output readouts may also be useful. When the food temperature reaches the target temperature, cooking is terminated by the processing unit. Other configurations, such as adjusting the cooking temperature or power, may also be useful.

FIG. 7b illustrates an open cooking environment application 705 with a sensor module. The open cooking environment application may include a cooker 771. As shown, the cooker is a range with burners 774. The range may be electric or gas-operated. Other types of cookers may also be applicable. For example, the cooker may be a grill. The grill may be an electric grill, gas grill, charcoal grill or wood grill.

In one embodiment, a sensor module 700 is disposed over the range. For example, as shown, the sensor module is disposed in a hood 781 located above the cooker. The sensor module, for example, is a standalone sensor module. The distance between the sensor module and the cooker may depend on the setup. Preferably, the sensor module includes an FOV which is sufficient to cover the complete cooking area, such as all the burners of the range. Alternatively, multiple sensor modules may be employed.

The sensor module is coupled to a sensor controller unit 784. The sensor controller, for example, may be disposed in a sensor controller housing. The sensor controller controls the operations of the sensor module, including providing power. In the case where the sensor module includes an external air supply unit, the air supply unit is located in the controller housing. The air supply unit is in fluid communication with the air chamber by, for example, tubing or pipe.

In one embodiment, the sensor controller includes a processing unit, an input panel and an output panel. The input panel provides a user with an input interface to set the target temperature. The processing unit controls the oven based on the input cooking parameters by the user. In addition, the processing unit controls the air supply unit to supply airflow to the sensor module to keep it cool and prevent condensation of the sensing window when cooking starts. During cooking, the processing unit continuously senses the food temperature. The output panel may include an output interface to provide the user with the current food temperature and cooking time. Other output readouts may also be useful. When the food temperature reaches the target temperature, the controller notifies the user that the target temperature has been reached and to terminate cooking. The notification may be a readout and/or an alarm notification. The notification may, in some embodiments, also include notification to a designated user device, such as a mobile phone.

Although the IR sensor module is implemented in a cooking environment, it is understood that the IR sensor module may also be employed for other applications. In addition, the sensor module may employ other types of sensors, such as non-IR imaging sensors.

The present disclosure may be embodied in other specific forms without departing from the spirit or essential characteristics thereof. The foregoing embodiment, therefore, are to be considered in all respects illustrative rather than limiting the invention described herein. The scope of the invention is thus indicated by the appended claims, rather than by the foregoing description, and all changes that come within the meaning and range of equivalency of the claims are intended to be embraced therein.

What is claimed is:

1. An imaging sensor module comprising:
a face plate having front and back major face plate surfaces, the face plate includes a face plate opening which serves as a window for an imaging sensor of the sensor module;
an air chamber unit, the air chamber unit includes
an air chamber plate with front and back major air chamber plate surfaces, the front air chamber plate surface is disposed on the back face plate surface, the air chamber plate includes an air chamber plate opening which corresponds to the face plate opening,
an imaging cover having front and back major cover surfaces, the front imaging surface is disposed on the back air chamber plate surface and covers the air chamber plate opening,
an air conduit disposed on the back air chamber plate surface, wherein the air conduit is configured to direct airflow from an air supply unit across the front and back cover surfaces to produce an air curtain which serves as a barrier to prevent condensation on the cover and to maintain the cover cool; and
a sensor unit, the sensor unit includes
a sensor bracket mounted to the sensor module,
the imaging sensor mounted onto the sensor bracket, wherein the sensor is configured to view through the imaging cover, the air chamber plate opening and the face plate opening,
a sensor controller for controlling operation of the imaging sensor.

2. The sensor module of claim 1 wherein the imaging sensor comprises an infrared (IR) imaging sensor.

3. The sensor module of claim 2 wherein the IR imaging sensor comprises a thermoelectric-based micro-electromechanical system (MEMS) detector embedded into an integrated circuit with high complementary metal oxide semiconductor (CMOS) integration.

4. The sensor module of claim 2 wherein the sensor module is integrated into an enclosed cooking environment.

5. The sensor module of claim 2 wherein the sensor module is configured as a standalone unit for use in an open cooking environment.

6. The sensor module of claim 2 wherein:
the sensor mounting bracket is mounted on the back face plate surface;
the sensor mounting bracket is configured to position the sensor over the imaging cover to enable the sensor to view through the cover, the air chamber plate opening and the face plate opening

7. The sensor module of claim 2 comprises a heat dissipation unit to maintain the imaging sensor cool.

8. The sensor module of claim 2 wherein the air supply unit comprises an external air supply unit, the air supply unit is connected to an air inlet connected to the air conduit of the air chamber unit.

9. The sensor module of claim 2 wherein the air supply unit comprises an integrated air supply unit, the integrated air supply unit is disposed within the air chamber unit to supply airflow to the air conduit of the air chamber unit.

10. The sensor module of claim 1 wherein:
the sensor mounting bracket is mounted on the back face plate surface;
the sensor mounting bracket is configured to position the sensor over the imaging cover to enable the sensor to view through the cover, the air chamber plate opening and the face plate opening

11. The sensor module of claim 1 comprises a heat dissipation unit to maintain the imaging sensor cool.

12. The sensor module of claim 1 wherein the air supply unit comprises an external air supply unit, the air supply unit is connected to an air inlet connected to the air conduit of the air chamber unit.

13. The sensor module of claim 1 wherein the air supply unit comprises an integrated air supply unit, the integrated air supply unit is disposed within the air chamber unit to supply airflow to the air conduit of the air chamber unit.

14. A method for forming an imaging sensor module comprising:
providing a face plate having front and back major face plate surfaces, the face plate includes a face plate opening which serves as a window for an imaging sensor of the sensor module;
providing an air chamber unit, the air chamber unit includes
an air chamber plate with front and back major air chamber plate surfaces, the air chamber plate includes an air chamber plate opening,
an imaging cover having front and back major cover surfaces, the front imaging surface is disposed on the back air chamber plate surface and covers the air chamber plate opening,
an air conduit disposed on the back air chamber plate surface, wherein the air conduit is configured to direct airflow from an air supply unit across the front and back cover surfaces to produce an air curtain which serves as a barrier to prevent condensation on the cover and to maintain the cover cool; and
attaching the air chamber unit to the back face plate surface, wherein the air chamber plate opening corresponds to the face plate opening;
providing a sensor unit, the sensor unit includes
a sensor bracket with the imaging sensor mounted thereon,
a sensor controller for controlling operation of the imaging sensor; and
attaching the sensor bracket of the sensor unit to the sensor module, wherein the imaging sensor is configured to view through the imaging cover, the air chamber plate opening and the face plate opening.

15. The method of claim 14 wherein the imaging sensor comprises an infrared (IR) imaging sensor.

16. The method of claim 15 wherein the sensor module is integrated into an enclosed cooking environment to sense temperature of food being cooked.

17. The method of claim 15 wherein the sensor module is a standalone sensor module configured to sense temperature of food being cooked in an open cooking environment.

18. The method of claim 15 wherein the imaging cover comprises an IR transparent imaging cover.

19. The method of claim 15 wherein the IR imaging sensor comprises a thermoelectric-based micro-electromechanical system (MEMS) detector embedded into an integrated circuit with high complementary metal oxide semiconductor (CMOS) integration.

20. The method of claim 14 wherein attaching the sensor bracket to the sensor module comprises attaching the sensor bracket to the back faceplate surface.
